(19) United States
(12) Patent Application Publication
(10) Pub. No.: US 2005/0200274 A1
(43) Pub. Date: Sep. 15, 2005

(54) Laminate for forming substrate with wires, such substrate with wires, and method for forming it

(75) Inventor: Takehiko Hiruma, Yonezawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASASHI GLASS COMPANY, LIMITED, Tokyo (JP)

(21) Appl. No.: 11/070,198

(22) Filed: Mar. 3, 2005

(30) Foreign Application Priority Data
Mar. 10, 2004 (JP) 2004-067193

(51) Int. Cl. H05B 33/06; H05B 33/10

(52) U.S. Cl. 313/503; 313/506

(57) ABSTRACT

To provide a laminate for forming a substrate with wires, which has a low resistance, is free from hillocks, has a small surface roughness and is excellent in alkali resistance and corrosion resistance, particularly a laminate suitable for a flat panel display such as an organic EL display, a method for forming a substrate with wires by etching the laminate, and the substrate with wires thereby obtained. A laminate for forming a substrate with wires, which comprises a substrate, a conductive layer containing an Al—Nd alloy as the major component and having a content of Nd of from 0.1 to 6 atomic % based on all components, formed on the substrate, and a capping layer containing a Ni—Mo alloy as the major component, formed on the conductive layer; a method for forming the laminate by sputtering, and a substrate with wires, comprising the laminate which is patterned in a flat form.

The present invention relates to a substrate with wires, to be used as electrode wires for a flat panel display such as an organic electroluminescence (organic EL) display, a method for forming it, and a laminate for forming the substrate with wires, useful for this purpose.

Flat panel display is increasingly in demand along with a high level of informatization in recent years. Recently, self-luminous type organic EL display capable of being driven at a low voltage has attracted attention as a display of next generation, since it is far superior to conventional LCD or PDP from the viewpoint of quick response, visibility, luminance, etc. Organic EL device basically has a structure wherein between a transparent electrode (an anode) of tin-doped indium oxide (ITO) and a metal electrode (a cathode), organic layers such as a hole transport layer, a light emission layer, an electron transport layer, etc. are formed in this order from the anode side. For colorization and high definition in recent years, it is necessary to further lower the resistance of the ITO layer, but it is already close to the limit to reduce the resistance of the ITO layer which has been heretofore used for LCD, etc. Therefore, as is widely adopted in thin film transistor (TFT) liquid crystal display (LCD), resistance reduction of a device circuit has been realized by using a low resistance metal such as Al or an Al alloy as supporting wires and combining it with an electrode made of an ITO layer.

Al or an Al alloy has low resistance. Further, Al oxide was likely to be formed on its surface, and there was a trouble such that even if it was attempted to take electrical contact with another metal, the contact resistance was so high that it was not practically useful as it was. Therefore, in many cases, it is common to cap Al or an Al alloy with Mo or a Mo alloy (with Cr, Ti, Ta, Zr, Hf or V) (e.g. JP-A-13-311954). Here, Mo may be subjected to etching with the same etching solution as for Al, and it is accordingly possible to carry out patterning of Al and Mo together in a step of photolithography to form the supporting wires.

However, Mo is usually poor in humidity resistance and susceptible to corrosion with moisture in air. Accordingly, there has been a problem that when Mo is used as a wiring material for EPD, the wires tend to deteriorate. On the other hand, if Al is capped with a metal having high humidity resistance such as Cr, etching can not be carried out with the same etching solution as for Al as mentioned hereinafter, and thus, there has been a problem that it is difficult to carry out patterning all at once.

As a solution to such a problem, a laminate is conceivable wherein Al is used as a conductive layer, and a Ni—Mo alloy having high humidity resistance and capable of being subjected to patterning together with Al, is used as a capping layer. Certainly, in such a case, wires will not be deteriorated even if left to stand under a high humidity condition. However, with such a laminate, hillocks (protrusions) are likely to be formed during the formation of the conductive layer, which causes deterioration of the coverage by the Ni—Mo alloy layer, and thus there has been a problem that Al is exposed, and by alkali treatment e.g. during washing to form a display device, during development in a photolithographic step and during peeling of the resist, Al will be eluted to from holes thereby to increase the resistance of wires.

It is an object of the present invention to provide a laminate for forming a substrate with wires, which has a low resistance, is substantially free from formation of hillocks, has a small surface roughness and is excellent in alkali resistance, a method for forming a substrate with wires, by etching such a laminate, and the substrate with wires thereby obtained. It is particularly an object of the present invention to provide a laminate for forming a substrate with wires particularly suitable for electrode wires to be used for a flat panel display such as an organic EL display, a method for forming a substrate with wires by etching such a laminate, and the substrate with wires thereby obtained.

The present inventor has conducted an extensive study in view of the prior art and has found that by using an Al—Nd alloy as a conductive layer, hillocks tend to be scarcely formed and the surface roughness tends to be small and that when a capping layer containing as the major component a Ni—Mo alloy which can be etched with an Al etching solution, is formed on the conductive layer, the capping layer effectively prevent exposure of the Al—Nd alloy to improve the alkali resistance and corrosion resistance. As a result, it has been possible to obtain a substrate with wires, which has a low resistance, is substantially free from formation of hillocks, has a small surface roughness and is excellent in alkali resistance and corrosion resistance, and the present invention has been accomplished.

Thus, the present invention provides a laminate for forming a substrate with wires, which comprises a substrate, a conductive layer containing an Al—Nd alloy as the major component and having a content of Nd of from 0.1 to 6 atomic % based on all components, formed on the substrate, and a capping layer containing a Ni—Mo alloy as the major component, formed on the conductive layer.

The laminate of the present invention preferably comprises a substrate, a conductive layer containing an Al—Nd alloy as the major component and having a content of Nd of from 0.1 to 3 atomic % based on all components, formed on the substrate, and a capping layer containing a Ni—Mo alloy as the major component, formed on the conductive layer.

In the laminate of the present invention, it is preferred that between the conductive layer and the substrate, an ITO layer and an underlayer are arranged in this order from the side of the substrate.

In the laminate of the present invention, it is preferred that the underlayer is a layer containing Mo or a Mo alloy as the major component.

In the laminate of the present invention, it is preferred that an anti-Ni-diffusion layer having a composition different from the capping layer is formed between the conductive layer and the capping layer and/or between the conductive layer and the underlayer.

In the laminate of the present invention, it is preferred that the anti-Ni-diffusion layer is a layer containing Mo, a Mo—Nb alloy or a Mo—Ta alloy as the major component.

In the laminate of the present invention, it is preferred that in the capping layer, the content of Ni is form 30 to 95 atomic % based on all components and the content of Mo is from 5 to 70 atomic % based on all components.

In the laminate of the present invention, it is preferred that in the anti-Ni-diffusion layer, the content of Mo is from 80 to 100 atomic % based on all components, and the content of Nb or Ta is from 0 to 20 atomic % based on all components.

Further, the present invention provides a substrate with wires, which comprises any laminate as defined above, which is patterned in a flat form.

The substrate with wires of the present invention is preferably applied to an organic El display device.

Further, the present invention provides a method for forming a substrate with wires, which comprises forming by sputtering a conductive layer containing an Al—Nd alloy as the major component on a substrate and a capping layer containing a Ni—Mo alloy as the major component on the conductive layer, to obtain a laminate for forming a substrate with wires, and then, patterning the laminate in a flat form by a photolithographic method.

In the accompanying drawings:

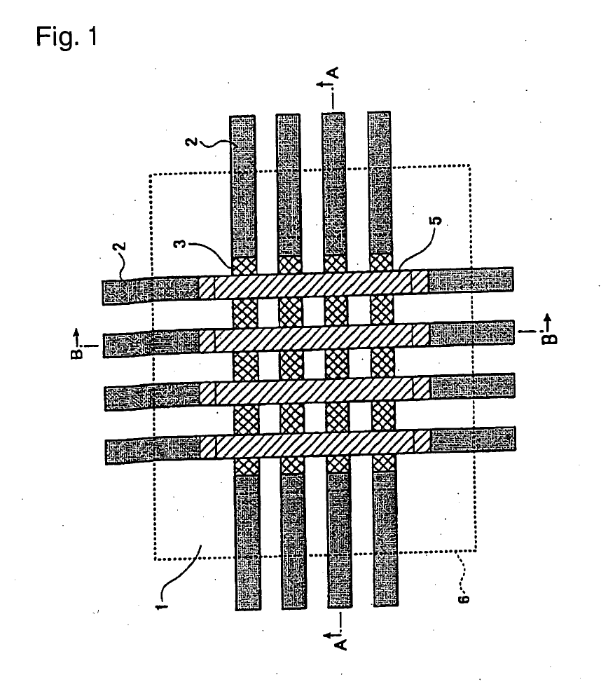

FIG. 1 is a partly omitted front view showing an embodiment of the substrate with wires obtainable by patterning the laminate of the present invention.

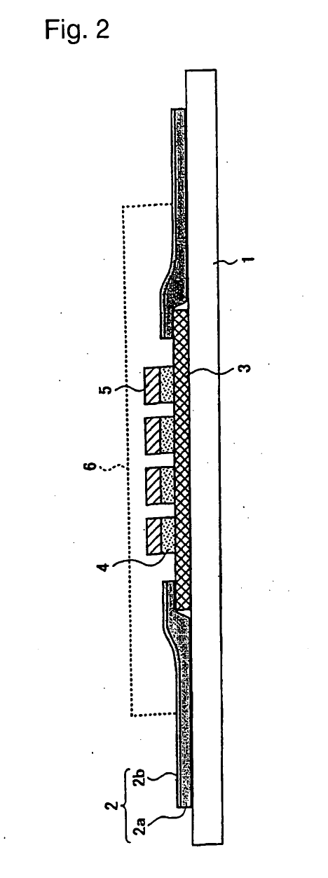

FIG. 2 is a cross-sectional view taken along line A-A in FIG. 1.

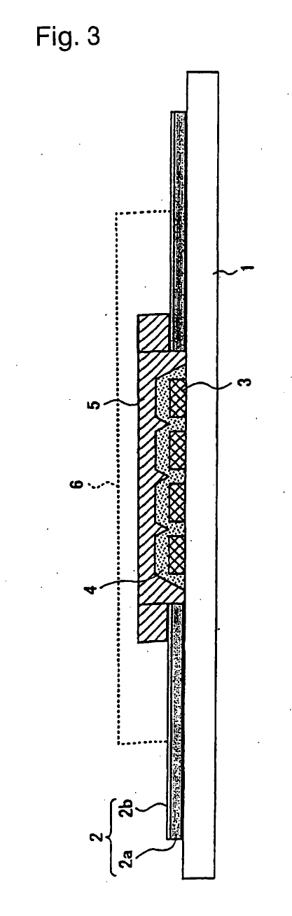

FIG. 3 is a cross-sectional view taken along line B-B in FIG. 1.

In the drawing, reference numeral 1 represents a glass substrate, 2 a wire, 2a an Al series metal layer, 2b a Ni—Mo ally layer, 3 an ITO anode, 4 an organic layer, 5 an Al cathode, and 6 a sealed can.

The laminate of the present invention has a low resistance, is substantially free from formation of hillocks, has a small surface roughness and is excellent in alkali resistance and corrosion resistance. If a laminate with wires obtained from such a laminate, is used, it is possible to avoid elution of Al in the conductive layer to increase the resistance of wires in the photolithographic step or at the time of forming the display device. Accordingly, it is possible to prepare a highly reliable high definition display. It is particularly effectively useful for an organic EL display which has a long useful life of the device and for which low resistance of wires is desired to improve the light emission characteristics.

The laminate for forming a substrate with wires according to the present invention is basically a laminate comprising a substrate/a conductive layer/a capping layer but includes various multilayer laminates such as a laminate comprising a substrate/an ITO layer/an underlayer/a conductive layer/a capping layer i.e. having an ITO layer and an underlayer arranged in this order from the substrate side between the substrate and the conductive layer, and a laminate comprising a substrate/an ITO layer/an underlayer/an anti-Ni-diffusion layer/a conductive layer/an anti-Ni-diffusion layer/a capping layer i.e. having an anti-Ni-diffusion layer between the conductive layer and the capping layer and/or between the underlayer and the conductive layer.

The substrate to be used in the present invention is not necessarily in a flat plate-like shape but may have a curved plane or a different shape. The substrate may, for example, be a transparent or opaque glass substrate, a ceramic substrate, a plastic substrate or a metal substrate. However, when it is to be used for an organic EL device having a structure where light is emitted from the substrate side, the substrate is preferably transparent, and a glass substrate is particularly preferred from the viewpoint of the strength and heat resistance. As such a glass substrate, a colorless transparent soda lime glass substrate, a quartz glass substrate, a borosilicate glass substrate or an alkali-free glass substrate may, for example, be mentioned. The thickness of the glass substrate to be used for an organic EL device is preferably from 0.2 to 1.5 mm from the viewpoint of the strength and transmittance.

The laminate for forming a substrate with wires according to the present invention is a laminate which essentially comprises two layers i.e. a conductive layer containing an Al—Nd alloy as the major component (which may hereinafter be referred to simply as the Al—Nd alloy layer) on the substrate and a capping layer containing a Ni—Mo alloy as the major component (which may hereinafter be referred to simply as the Ni—Mo alloy layer) on the conductive layer.

In the laminate of the present invention, the conductive layer contains the Al—Nd alloy as the major component, whereby it is possible to suppress formation of hillocks at the time of forming the layer, while maintaining the wires to have low resistance. Further, when the Al—Nd alloy is the major component, the covering property by the capping layer containing the Ni—Mo alloy as the major component is good, whereby exposure of the Al—Nd alloy can be prevented, and the alkali resistance of the laminate can be improved.

The Al content in the Al—Nd alloy layer constituting the conductive layer is from 94 to 99.9 atomic % based on all components with a view to lowering the resistance of wires, and the Nd content is from 0.1 to 6 atomic % based on all components. As the Nd content increases, the resistance immediately after deposition increases, but by carrying out heat treatment after the deposition, the resistance can be lowered to the same level as Al. In the case of e.g. an organic EL display device, it is usually necessary to carry out thermal treatment to form a display device after forming supporting wires, but after forming a display device by using an Al—Nd alloy for the laminate for forming the wires, if the Nd content is less than 0.1 atomic %, hillock resistance tends to be inadequate, and if it exceeds 6 atomic %, resistance after the heat treatment increases beyond the resistance of Al. Accordingly, it is restricted to a level of from 0.1 to 6 atomic %.

The Al—Nd alloy layer may contain Ti, Mn, Si, Na, O, etc. as impurities, and their total content is preferably at most 1 mass %.

The thickness of the Al—Nd alloy layer is preferably from 100 to 500 nm, more preferably from 150 to 400 nm, so that adequate electroconductivity and good patterning processability can be obtained.

Further, the Al—Nd layer has a characteristic such that immediately after its formation, the resistance tends to be slightly high, but the resistance can be lowered by baking. It is considered that immediately after its formation, Nd is mixed with Al, which may lead to an increase of the resistance, but by the heat treatment, Nd moves to the grain boundaries so that Nd and Al be separated, whereby the resistance decreases.

The capping layer formed on the conductive layer is a layer containing a Ni—Mo alloy as the major component. Since the Ni—Mo alloy is excellent in humidity resistance, it is capable of maintaining low resistance of the wires formed and also capable of improving the reliability of an electronic device employing a substrate with wires thereby obtained. Further, an obtainable laminate for forming a substrate with wires permits precise patterning. Further, when patterning is carried out by photolithography, the capping layer (the Ni—Mo alloy layer) and the conductive layer (the Al—Nd alloy layer) can be etched at substantially the same rate with the same etching liquid (an acidic aqueous solution). Namely, the capping layer and the conductive layer may be subjected to patterning together.

If the etching rate between the conductive layer and the capping layer is substantially different, over-etching or a residue tends to result during the formation of the wires, such being undesirable. The etching rate of the Ni—Mo alloy layer can easily be adjusted by changing the compositional ratio of Ni and Mo depending on the type of the etching liquid. As the ratio of Mo to Ni becomes large, the etching rate becomes high.

The Ni content in the Ni—Mo alloy layer is preferably from 30 to 95 atomic %, more preferably from 65 to 85 atomic %, based on all components. If the Ni content is less than 30 atomic %, the humidity resistance of the Ni—Mo alloy layer tends to be inadequate, and if it exceeds 95 atomic %, the etching rate with an etching liquid tends to be low, and it tends to be difficult to adjust it to the same level as the etching rate of the conductive layer. Further, the content of Mo in the Ni—Mo alloy layer is preferably from 5 to 70 atomic %, more preferably from 15 to 35 atomic %, based on total components. If the content of Mo is less than 5 atomic %, the etching rate by the etching liquid tends to be low, and it tends to be difficult to adjust it to the same level as the etching rate of the conductive layer, and if it exceeds 70 atomic %, the humidity resistance of the Ni—Mo alloy layer tends to be inadequate. The total content of Ni and Mo in the Ni—Mo alloy layer is preferably from 90 to 100 atomic %.

The Ni—Mo alloy layer may contain one or more metals such as Fe, Ti, V, Cr, Co, Zr, Nb, Ta and W, within a range not to deteriorate the humidity resistance, the etching property, etc., for example at most 10 atomic %.

The thickness of the capping layer is preferably from 10 to 200 nm, more preferably from 15 to 50 nm, from the viewpoint of the humidity resistance and the patterning efficiency.

The laminate for forming a substrate with wires of the present invention is preferably formed by a sputtering method. For example, it can be formed by a combination of a step of forming a conductive layer on one surface of a glass substrate by sputtering in an inert gas atmosphere by using an Al—Nd alloy target and a step of forming a capping layer on the conductive layer by sputtering by using a Ni—Mo alloy target. By such a sputtering method, it is possible to easily form a laminate for forming a substrate with wires having a uniform layer thickness over a large surface area.

The Al—Nd alloy target may, for example, be an Al alloy target containing Nd or an Al non-alloy target containing Nd.

Further, the Ni—Mo alloy target may, for example, be a Ni—Mo alloy target, a Ni—Mo alloy target containing Fe, or a Ni—Mo non-alloy target containing Fe. The Ni—Mo non-alloy target containing Fe, includes, for example, one formed by combining in a mosaic form Ni plates, Mo plates and Fe plates smaller than the target area, and one formed by combining a Ni—Mo alloy target plate and a Fe plate.

The laminate for forming a substrate with wires of the present invention may, for example, be formed specifically by the following method.

An Al—Nd alloy target and a Ni—Mo alloy target are fixed separately to the cathode of a DC magnetron sputtering device. Further, a substrate is fixed to a substrate holder. Then, the interior of the deposition chamber is evacuated to vacuum and then an Ar gas is introduced as sputtering gas. Although He, Ne or Kr gas can, for example, be used instead of the Ar gas, the Ar gas is preferred since it is inexpensive and the discharge is thereby stable. The sputtering pressure is preferably from 0.1 to 2 Pa. Further, the back pressure is preferably from 1×10⁻⁶ to 1×10⁻² Pa. The substrate temperature is preferably from room temperature to 400° C., more preferably from room temperature to 250° C., particularly preferably from room temperature to 150° C.

Firstly, on the substrate, an Al—Nd alloy layer is formed as a conductive layer by sputtering. Then, on the conductive layer, a Ni—Mo alloy layer is formed as a capping layer by sputtering, thereby to form a laminate for forming a substrate with wires.

When the Al—Nd alloy layer is to be formed, Al and Nd may be used as separate targets respectively to form the alloy layer, but from the viewpoint of efficiency in the control of the composition of the conductive layer and improvement of the uniformity, it is preferred to preliminarily prepare an Al—Nd alloy having a predetermined composition and use it as the target.

When the Ni—Mo alloy layer is to be formed, Ni and Mo may be used as separate targets respectively to form the alloy layer, but it is preferred to preliminarily prepare a Ni—Mo alloy having a predetermined composition and use it as the target.

The laminate for forming a substrate with wires of the present invention may have an anti-Ni-diffusion layer having a composition different from the capping layer, between the Ni—Mo alloy layer (the capping layer) and the Al—Nd alloy layer (the conductive layer) and/or between the Al—Nd alloy layer (the conductive layer) and a Ni—Mo alloy layer (the underlayer) as described hereinafter.

If heat treatment is carried out when the conductive layer is in contact with the capping layer, or the conductive layer is in contact with the underlayer, Ni will diffuse into the conductive layer from the capping layer and/or the underlayer, whereby the resistance of the conductive layer will increase. Such increase of the resistance can be prevented by the anti-Ni-diffusion layer. Such an anti-Ni-diffusion layer may preferably be formed also by a sputtering method.

The thickness of the anti-Ni-diffusion layer is preferably from 10 to 200 nm, more preferably from 15 to 50 nm, from the viewpoint of the barrier effect and patterning efficiency.

The anti-Ni-diffusion layer is preferably a Mo series metal layer containing Mo as the major component, because it can be etched together with the capping layer and the conductive layer. Specifically, Mo, a Mo—Nb alloy or a Mo—Ta alloy may, for example, be mentioned. The Mo content in the Mo series metal layer is preferably from 80 to 100 atomic %. Further, the Nb or Ta content in the Mo series metal layer is preferably from 0 to 20 atomic %.

When the Mo series metal layer is formed as the anti-Ni-diffusion layer between the conductive layer and the capping layer, the Mo series metal will be exposed at the cross section of pattern after the patterning, but improvement of the humidity resistance will not be impaired, since the major portion of the Mo series metal layer is covered by the capping layer and the conductive layer.

For the laminate for forming a substrate with wires of the present invention, the Ni—Mo alloy layer (the capping layer) may be subjected to treatment such as oxidizing, nitriding, oxynitriding, oxycarbonizing or oxycarbonitriding. Namely, also by applying such treatment during the formation of the capping layer, it is possible to prevent increase of the resistance like by the above-mentioned anti-Ni-diffusion layer. Such treatment can be carried out by a method of employing a mixed gas comprising a reactive gas such as O₂, N₂, CO or CO₂ and Ar gas, as the sputtering gas at the time of forming the Ni—Mo alloy layer by sputtering. By carrying out such treatment, oxygen, nitrogen or carbon can be incorporated in the Ni—Mo alloy layer. The content of the reactive gas is preferably from 5 to 50 vol %, more preferably from 20 to 40 vol %, from the viewpoint of the anti-Ni-diffusion effect.

Further, the laminate for forming a substrate with wires of the present invention, may have a tin-doped indium oxide layer (ITO layer). In such a case, there is a disadvantage that the Al—Nd alloy layer will have a large contact resistance with the ITO layer. Therefore, it is practically preferred to interpose the above underlayer to form a laminate of the substrate/the ITO layer/the underlayer/the conductive layer/the capping layer. The ITO layer can be used as a transparent electrode. Accordingly, in the laminate for forming a substrate with wires of the present invention, after forming the ITO layer on the substrate, if a necessary portion is masked at the time of forming the underlayer, the conductive layer and the capping layer, the masked portion will be composed solely of the ITO layer without the underlayer, the conductive layer or the capping layer, and it can be used as an electrode to obtain, for example, an organic EL device, if necessary, by forming an organic layer thereon. On the other hand, at a portion not masked, the underlayer, the conductive layer and the capping layer will be formed on the ITO layer, and the ITO layer as an electrode will be connected to the underlayer, the conductive layer and the capping layer as wires, without any step.

The ITO layer can be formed on, for instance, a glass substrate by using an electron beam method, a sputtering method, an ion plating method or the like. The ITO layer can preferably be formed by sputtering, using, for instance, an ITO target containing SnO₂ in 3 to 15 mass % based on the total amount of In₂O₃ and SnO₂. The sputtering gas is preferably a mixed gas of O₂ and Ar, and the concentration of O₂ gas is preferably 0.2 to 2 volume %.

The thickness of the ITO layer is preferably from 50 to 300 nm, more preferably from 100 to 200 nm.

Then, the underlayer, the conductive layer and the capping layer are formed on the ITO layer by sputtering to obtain the laminate for forming a substrate with wires having the ITO layer.

The conductive layer has the disadvantage of large contact resistance with the ITO layer. Accordingly, when the ITO layer is formed between the substrate and the conductive layer, the underlayer is formed under the conductive layer in order to prevent an increase of the contact resistance between the ITO layer and wires. It is preferable that the underlayer is a Mo series metal layer containing Mo or a Mo alloy as the major component. The Mo series metal layer containing Mo or a Mo alloy as the major component means that the content of Mo or a Mo alloy in the layer is from 90 to 100 atomic %.

The thickness of the underlayer is preferably 10 to 200 nm, more preferably, 15 to 50 nm, from the viewpoint of the barrier effect and patterning efficiency.

The Ni—Mo alloy layer is preferably used as the Mo series metal. When the Ni—Mo alloy layer is used as the underlayer, the content of Ni in the alloy layer is preferably from 30 to 95 atomic %, more preferably from 65 to 85 atomic % based on all components, and the content of Mo is preferably from 5 to 70 atomic %, more preferably from 15 to 35 atomic % based on all components. Further, one or more metals such as Ti, V, Cr, Fe, Co, Zr, Nb, Ta and W may be contained in an amount not to cause deterioration of the humidity resistance, etching efficiency, etc.

The composition of the Ni—Mo alloy layer as the underlayer formed under the conductive layer may be the same as or different from the composition of the Ni—Mo alloy layer as the capping layer. When the compositions of upper and lower Ni—Mo alloy layers are adjusted so that the etching rate increases in the order of the Ni—Mo alloy layer (capping layer), the Al—Nd alloy layer (conductive layer) and the Ni—Mo alloy layer (underlayer), the patterned portion can be processed in a taper-like form in cross section. It is also advantageous because the abrasion resistance and adhesive properties can be improved. Further, an anti-Ni-diffusion layer may be formed between the conductive layer and the Ni—Mo alloy layer as the underlayer. The structure of the anti-Ni-diffusion layer is the same as the above-described anti-Ni-diffusion layer provided between the conductive layer and the capping layer.

The underlayer may be subjected to treatment such as oxidizing, nitriding, oxynitriding, oxycarbonizing or oxycarbonitriding. By such treatment, oxygen, nitrogen, carbon, etc. will be incorporated to the underlayer, whereby an increase of the resistance can be prevented like by the above-mentioned anti-Ni-diffusion layer. Such treatment is carried out by a method of employing a mixed gas comprising a reactive gas such as O₂, N₂, CO or CO₂, and Ar gas, as the sputtering gas. The content of the reactive gas is preferably from 5 to 50 vol %, particularly preferably from 20 to 40 vol %, from the viewpoint of the anti-Ni-diffusion effect. In a case where the underlayer contains oxygen, the content of oxygen in the underlayer is preferably from 5 to 20 atomic % based on all atoms in the layer from the viewpoint of the anti-Ni-diffusion effect. In a case where the underlayer contains carbon, the content of carbon in the underlayer is preferably from 0.1 to 15 atomic %, based on all atoms in the layer from the viewpoint of the anti-Ni-diffusion effect.

When the Mo series metal layer is formed as an underlayer under the conductive layer, Mo series metal is exposed at the cross-sectioned portion of pattern after the patterning. However, the improvement of the humidity resistance will not be impaired, since the major portion of the Mo series metal layer is covered with the substrate or the ITO film, and the conductive layer.

Further, the laminate of the present invention may have a silica layer between the conductive layer and the substrate. The silica layer may be in contact with the substrate or may be without contact thereto. Usually, the silica layer is formed by sputtering a silica target. When a glass substrate is used as the substrate, it prevents the deterioration of the conductive layer by preventing migration of an alkali component in the glass substrate to the conductive layer. The thickness of the silica layer is preferably 5 to 30 nm.

The laminate of the present invention has a low resistance, is substantially free from formation of hillocks, has a small surface roughness and is excellent in the alkali resistance and corrosion resistance. The laminate thus obtained is subjected to etching preferably by a photolithographic method to form a substrate with wires. And, if such a substrate with wires is used for preparation of e.g. an organic EL display, a highly reliable wires with low resistance can be constructed, and it is thereby possible to obtain an organic EL display having a long useful life and improved light-emitting characteristics.

In the laminate of the present invention, an Al—Nd alloy having Nd added to Al, is used as a conductive layer. Accordingly, as compared with the laminate wherein Al is used as a conductive layer, the sheet resistance immediately after the deposition tends to be poor. However, with the laminate of the present invention, the resistance decreases by heat treatment at a high temperature, and after the heat treatment, its sheet resistance becomes equal to that of the laminate wherein Al is used as a conductive layer. Especially when it is to be used for an organic EL device, it is required to be subjected to a high temperature in the step for preparation of a separator for the cathode, and it is preferred that a desired resistance level can be maintained after subjected to such a step. The sheet resistance of the laminate is practically preferably at most 0.4 Ω/□ before the heat treatment and at most 0.2 Ω/□ after the heat treatment (e.g. at 320° C. for 1 hour in atmospheric air).

The laminate of the present invention is preferred further in that hillocks are scarcely formed on the surface during the formation of the conductive layer. If hillocks are formed on the surface, the coverage of the capping layer to be formed on the conductive layer tends to deteriorate, and the conductive layer is likely to be exposed. Accordingly, by alkali treatment at the time of washing to form a display device, at the time of development in the photolithographic step or at the time of peeling the resist, the conductive layer is likely to be eluted to have holes, whereby the sheet resistance will increase. With the laminate of the present invention, hillocks are scarcely formed, and even if it is subjected to alkali treatment, its sheet resistance will not change, such being desirable. For the practical purpose, the range for the change in the sheet resistance is preferably at most 5% as between before and after the alkali treatment. Further, the surface roughness of the laminate is preferably such that Ra is at most 12 nm, and Rz is at most 150 nm, where Ra is the arithmetic average height and Rz is the maximum height, as defined in JIS B0601 (2001).

A photoresist is coated on the capping layer as the outermost surface of the laminate; a pattern for wires is formed by baking; and an unnecessary portion of the metal layers such as the capping layer, the anti-Ni-diffusion layer, the conductive layer and the underlayer, is removed according to the pattern of the photo-resist by an etching liquid, whereby the substrate with wires is formed. The etching liquid is preferably an acidic aqueous solution such as phosphoric acid, nitric acid, acetic acid, sulfuric acid or hydrochloric acid, or a mixture thereof, or ammonium cerium nitrate, perchloric acid or a mixture thereof.

A mixed solution of phosphoric acid, nitric acid, acetic acid, sulfuric acid and water, is preferred. A mixed solution of phosphoric acid, nitric acid, acetic acid and water, is more preferred.

In the formation of the substrate with wires, each layer of the laminate, for example, each layer of (1) conductive layer/capping layer, (2) underlayer/conductive layer/capping layer or (3) underlayer/anti-Ni-diffusion layer/conductive layer/anti-Ni-diffusion layer/capping layer is subjected to etching to have the same pattern.

When the laminate has the ITO layer, the conductive layer/capping layer may be removed together with the ITO layer by an etching liquid. Or, the capping layer and the conductive layer may be previously removed, so that the ITO layer is separately removed. Or, the ITO layer may be previously patterned; the conductive layer and the capping layer are sputtered; and then, the capping layer/conductive layer other than the wire portion are removed.

Now, a preferred example of producing an organic EL display device by forming a substrate with wires by using the laminate of the present invention, will be described with reference to FIGS. 1 to 3. However, the present invention is not limited to such an example.

First, an ITO film is formed on a glass substrate 1. The ITO film is subjected to etching to form an ITO anode 3 of stripe pattern. Then, a Ni—Mo alloy layer (not shown) is formed as the underlayer by sputtering so as to cover the entire surface of the glass substrate. On the alloy layer, a Mo series metal layer (not shown) as the anti-Ni-diffusion layer, an Al—Nd alloy layer 2a as the conductive layer, a Mo series metal layer (not shown) as the anti-Ni-diffusion layer and a Ni—Mo layer 2b as the capping layer are formed in this order by sputtering to thereby obtain a laminate for forming a substrate with wires. Of course, the ITO layer may be formed entirely or partly on the glass substrate 1.

A photoresist is coated on the laminate. Unnecessary portions of the metal layers are removed by etching according to the pattern of the photoresist. When the photoresist is peeled off, wires 2 comprised of the Ni—Mo alloy layer (underlayer), the Mo series metal layer (anti-Ni-diffusion layer), the Al—Nd alloy layer (conductive layer) 2a, the Mo series metal layer (anti-Ni-diffusion layer) and the Ni—Mo alloy layer (capping layer) 2b is obtained. Then, ultraviolet ray-ozone treatment or oxygen-plasma treatment is applied to the entire laminate by irradiation and cleaning with ultraviolet rays. In the irradiation and cleaning with ultraviolet rays, ultraviolet rays are irradiated usually by a U.V. lamp to remove organic matters.

Then, an organic layer 4 having a hole transport layer, a light emission layer and an electron transport layer is formed on the ITO anode 3. When a cathode separator (separator) is to be formed, the separator is formed by photolithography before the organic layer 4 is formed by vacuum deposition.

An Al cathode 5 as a cathode back-electrode is formed by vacuum deposition so as to cross perpendicularly to the ITO anode 3 after the wires 2, the ITO anode 3 and the organic layer 4 are formed.

Then, the portion surrounded by a broken line is sealed with a resin to form a sealed can 6.

Since the substrate with wires of the present invention comprises the above-mentioned laminate wherein an Al—Nd alloy of low resistance is used for the conductive layer and a Ni—Mo alloy having a high corrosion resistance is used for the capping layer, it has a low resistance, is substantially free from formation of hillocks, has a small surface roughness and is excellent in the alkali resistance and corrosion resistance, whereby there is little possibility of deterioration of the wires.

In the following, the present invention will be described in detail with reference to Examples. However, the present invention is by no means limited thereto.

### EXAMPLE 1

A soda lime glass substrate having a thickness of 0.7 mm, a length of 100 mm and a width of 100 mm was cleaned. The glass substrate was set on a sputtering device. A RF magnetron sputtering was carried out by using a silica target to form a silica layer having a thickness of 20 nm on the substrate. Thus, glass substrate with a silica layer was obtained.

Then, a DC magnetron sputtering was carried out by using an ITO target (containing 10 mass % of SnO₂ based on the total amount of In₂O₃ and SnO₂) to form an ITO layer having a thickness of 150 nm, whereby the glass substrate with an ITO layer (referred to simply as the substrate) was obtained. As the sputtering gas, Ar gas containing 0.5 volume % of O₂ gas was used.

Then, on the entire surface of the glass substrate with an ITO layer (excluding the portion used for holding the substrate), a Ni—Mo alloy layer (underlayer) having a thickness of 50 nm was formed by a DC magnetron sputtering method using a Ni—Mo—Fe alloy target of 74:22:4 by atomic % and using Ar gas containing 33 vol % of CO₂ gas, as the sputtering gas. The backpressure was 1.3×10⁻³ Pa, the sputtering gas pressure was 0.3 Pa, and the power density was 4.3 W/cm². Further, the substrate was not heated. An elemental analysis of the underlayer was carried out by mean of ESCA, whereby the atomic ratio was such that Ni:Mo:Fe:O:C=59:20:2:11:8. The name of the apparatus of ESCA and the measuring conditions used for the analysis will be given hereinafter.

Then, on the underlayer, an Al—Nd alloy layer (conductive layer) having a thickness of 370 nm was formed by a DC magnetron sputtering method in an Ar gas atmosphere by using an Al—Nd alloy target of 99.8:0.2 by atomic %. The composition of the formed layer was equal to the composition of the target. The sputtering gas pressure was 0.3 Pa, and the power density was 4.3 W/cm². Further, the substrate was not heated.

Then, on the conductive layer, a Mo—Nb alloy layer (anti-Ni-diffusion layer) having a thickness of 30 nm was formed by a DC magnetron sputtering in an Ar gas atmosphere by using a Mo—Nb alloy target of 90:10 by atomic %. The composition of the formed layer was equal to the composition of the target. The sputtering gas pressure was 0.3 Pa, and the power density was 1.4 W/cm². Further, the substrate was not heated.

Further, on the anti-Ni-diffusion layer, a Ni—Mo alloy layer (capping layer) having a thickness of 50 nm was formed by a DC magnetron sputtering method in an Ar gas atmosphere by using a Ni—Mo—Fe alloy target of 74:22:4 by atomic %, whereby a laminate for forming a substrate with wires, was obtained. The composition of the formed layer was equal to the composition of the target. The sputtering gas pressure was 0.3 Pa, and the power density was 1.4 W/cm². Further, the substrate was not heated.

The surface roughness, the alkali resistance, the sheet resistance immediately after the deposition and the sheet resistance (heat resistance) after heat treatment, of the laminate for forming a substrate with wires, were measured by the following methods. The results are shown in Table 2.

The measuring methods are as follows.

(1) Surface roughness: The arithmetic average height (Ra) and the maximum height (Rz) defined in JIS B0601 (2001) were measured by means of an atomic force microscope (NanoScope 3a: manufactured by Digital Instrument). It is practically preferred that Ra is at most 12 nm, and Rz is at most 150 nm.

(2) Alkali resistance: The laminate was immersed in a 2.38% TMAH solution at room temperature for 10 minutes, whereby the change in the sheet resistance was measured for evaluation. The evaluation was made on such a basis that symbol ◯ represents a case where the change in sheet resistance is less than 5%, and symbol X represents a case where it is at least 5%.

(3) Sheet resistance: Measured by a four probe method by using Loresta IP MCP-T250, manufactured by Mitsubishi Chemical Corporation. It is practically preferably at most 0.4 Ω/□.

(4) Sheet resistance after heat treatment: Using a constant temperature chamber (PMS-P101, manufactured by Espec Corp.), the laminate was left to stand at 320° C. for 1 hour in atmospheric air, whereupon the sheet resistance was measure by a four probe method by means of the above-mentioned Loresta IP MCP-T250. It is practically preferably at most 0.2 Ω/□.

### EXAMPLE 2

A laminate for forming a substrate with wires, was obtained by carrying out sputtering by the same method and conditions as in Example 1 except that in Example 1, an Al—Nd alloy layer (conductive layer) having a thickness of 400 nm was formed by using an Al—Nd alloy target of 98:2 by atomic %. The thickness of the laminate is shown in Table 1. The arithmetic average height (Ra) and the maximum height (Rz), the alkali resistance, the sheet resistance immediately after the deposition, and the sheet resistance after heat treatment, were measured. The results are shown in Table 2.

### EXAMPLE 3

### Comparative Example

A laminate for forming a substrate with wires, was obtained by carrying out sputtering by the same method and conditions as in Example 1 except that in Example 1, an Al metal layer (conductive layer) having a thickness of 360 nm was formed by using an Al metal target. The arithmetic average height (Ra) and the maximum height (Rz), the alkali resistance, the sheet resistance immediately after the deposition and the sheet resistance after heat treatment, were measured. The results are shown in Table 2.

### EXAMPLE 4

### Comparative Example

A laminate for forming a substrate with wires, was obtained by carrying out sputtering by the same method and conditions as in Example 1 except that in Example 1, an Al—Si—Cu alloy layer (conductive layer) having a thickness of 430 nm was formed by using an Al—Si—Cu alloy target of 98.8:1:0.2 by atomic %. The arithmetic average height (Ra) and the maximum height (Rz), the alkali resistance, the sheet resistance immediately after the deposition and the sheet resistance after heat treatment, were measured. The results are shown in Table 2.

(Name of the Apparatus of ESCA and Measuring Conditions Used for the Elemental Analysis)

XPS measuring apparatus: JEOL JPS-9000MC (manufactured by JEOL)
X-ray source: Ms-Std rays, beam diameter: 6 mm
X-ray output: 10 kV, 10 mA
Charge correction: Flood gun
Cathode: −100 V
Bias: −10 V
Filament: 1.15 A

Measurement: The surface of 10 mm in diameter was subjected to sputter etching by Ar⁺ at a rate of 1 nm/sec for 10 nm, and its central portion was measured. The etching conditions were such that Ar⁺ ion beam of 800 eV was used, and the area was 10 mm in diameter. The detection angle of photoelectron was 90°. The incident energy pass of photoelectron into the energy analyzer was 20 eV. The peaks of Ni 3p_{3/2}, Mo 3d, Fe 2p_{3/2}, O 1s and C 1s, were measured. The peak areas were obtained, and by using the following relative sensitivity coefficients, the surface atomicity ratio was calculated.

Relative sensitivity coefficient:

| | |
|---|---|
| Ni 3p_{3/2} | 47.089 |
| Mo 3d | 39.694 |
| Fe 2p_{3/2} | 37.972 |
| O 1s | 10.958 |
| C 1s | 4.079. |

From Table 2, it is evident that when the conductive layer is an Al layer or an Al—Si—Cu alloy layer, the maximum height (Rz) is high at a level of 237 nm or 213 nm, and when the conductive layer is an Al—Nd alloy layer, Rz is low at a level of 86 nm or 60 nm. Further, in a case where the conductive layer is an Al—Nd alloy layer, the sheet resistance immediately after the deposition increases, but by carrying out heat treatment, the sheet resistance can be lowered to the same level as the sheet resistance of the laminate wherein the conductive layer is an Al layer. Further, as compared with Example 3 (Comparative Example), in Examples 1 and 2 (Working Examples of the invention), it was confirmed that formation of hillocks was suppressed.

TABLE 1

| | | | | Flow rate (vol %) of the | |
|---|---|---|---|---|---|
| | | | | sputtering gas during the | |
| | | | Layer | formation of underlayer (Ni—Mo | |
| | Construction | Construction of | thicknesses | layer) | |
| Example | of substrate | layers | (nm) | Ar | CO₂ |
| 1 | Glass/SiO₂/ITO | Ni—Mo/Al—0.2Nd/ | 50/370/30/50 | 67 | 33 |
| | | Mo—10Nb/Ni—Mo | | | |
| 2 | Glass/SiO₂/ITO | Ni—Mo/Al—2Nd/ | 50/400/30/50 | 67 | 33 |
| | | Mo—10Nb/Ni—Mo | | | |
| 3 | Glass/SiO₂/ITO | Ni—Mo/Al/ | 50/360/30/50 | 67 | 33 |
| | | Mo—10Nb/Ni—Mo | | | |
| 4 | Glass/SiO₂/ITO | Ni—Mo/Al—Si—Cu/ | 50/430/30/50 | 67 | 33 |
| | | Mo—10Nb/Ni—Mo | | | |

TABLE 2

| | | | | Sheet | |
|---|---|---|---|---|---|
| | | | | resistance | Sheet |
| | Arithmatic | | | immediately | resistance |
| | average | Maximum | | after the | after heat |
| | height Ra | height | Alkali | deposition | treatment |
| Example | (nm) | Rz (nm) | resistance | (Ω/□) | (Ω/□) |
| 1 | 7 | 86 | ◯ | 0.12 | 0.09 |
| 2 | 5 | 60 | ◯ | 0.26 | 0.11 |
| 3 | 15 | 237 | X | 0.10 | 0.10 |
| 4 | 18 | 213 | X | 0.11 | 0.08 |

By using the laminate for forming a substrate with wires of the present invention, it is possible to form a substrate provided with wires, which has a low resistance, is substantially free from formation of hillocks, has a small surface roughness and is excellent in the alkali resistance and corrosion resistance. And, it is possible to prepare a highly precise and highly reliable display. It is particularly useful for an organic EL display device which has a long useful life and which is desired to have a low resistance of wires in order to improve the light-emission characteristics.

The entire disclosure of Japanese Patent Application No. 2004-067193 filed on Mar. 10, 2004 including specification, claims, drawings and summary is incorporated herein by reference in its entirety.

1. A laminate for forming a substrate with wires, which comprises a substrate, a conductive layer containing an Al—Nd alloy as the major component and having a content of Nd of from 0.1 to 6 atomic % based on all components, formed on the substrate, and a capping layer containing a Ni—Mo alloy as the major component, formed on the conductive layer.

2. The laminate according to claim 1, wherein between the conductive layer and the substrate, an ITO layer and an underlayer are arranged in this order from the side of the substrate.

3. The laminate according to claim 2, wherein the underlayer is a layer containing Mo or a Mo alloy as the major component.

4. The laminate according to claim 2, wherein an anti-Ni-diffusion layer having a composition different from the capping layer is formed between the conductive layer and the capping layer and/or between the conductive layer and the underlayer.

5. The laminate according to claim 4, wherein the anti-Ni-diffusion layer is a layer containing Mo, a Mo—Nb alloy or a Mo—Ta alloy as the major component.

6. The laminate according to claim 1, wherein in the capping layer, the content of Ni is from 30 to 95 atomic % based on all components and the content of Mo is from 5 to 70 atomic % based on all components.

7. The laminate according to claim 1, wherein the thickness of the conductive layer is from 100 to 500 nm.

8. The laminate according to claim 1, wherein the capping layer further contains one or more metals selected from Fe, Ti, V, Cr, Co, Zr, Nb, Ta and W.

9. The laminate according to claim 1, wherein the thickness of the capping layer is from 10 to 200 nm.

10. The laminate according to claim 1, wherein the conductive layer is formed by sputtering.

11. The laminate according to claim 10, wherein the temperature of the substrate during the sputtering is from room temperature to 400° C.

12. The laminate according to claim 1, wherein the sheet resistance of the laminate is at most 0.4 Ω/□ before heat treatment.

13. The laminate according to claim 1, wherein the sheet resistance of the laminate is at most 0.2 Ω/□ after heat treatment.

14. The laminate according to claim 1, wherein Ra of the laminate is at most 12 nm.

15. The laminate according to claim 1, wherein Rz of the laminate is at most 150 nm.

16. A substrate with wires, which comprises the laminate as defined in claim 1 wherein the laminate is patterned in a flat form.

17. A method for forming a substrate with wires, which comprises forming by sputtering a conductive layer containing an Al—Nd alloy as the major component on a substrate and a capping layer containing a Ni—Mo alloy as the major component on the conductive layer, to obtain a laminate for forming a substrate with wires, and then, patterning the laminate in a flat form by a photolithographic method.
